(19) United States
(12) Patent Application Publication
(10) Pub. No.: US 2011/0041073 A1
(43) Pub. Date: Feb. 17, 2011

(54) Key-Based Storage and Retrieval of Information

(76) Inventors: Aaron C. Hoff, Kirkland, WA (US); Scott J. Counts, Seattle, WA (US)

Correspondence Address: MICROSOFT CORPORATION, ONE MICROSOFT WAY, REDMOND, WA, 98052, US

(21) Appl. No.: 12/541,984

(22) Filed: Aug. 17, 2009

(51) Int. Cl. G06F 3/048; G06F 21/00; G06F 15/16; G06F 21/20

(52) U.S. Cl. 715/741; 726/7

(57) ABSTRACT

An information interaction module (IIM) is described for interacting with information items using a hierarchical taxonomy of key elements. In one mode, the IIM allows a user to specify a key by successively entering a string of key elements which compose the key. At each stage in this operation, the IIM guides the users by identifying a set of key elements that can be entered next. Ultimately, the IIM retrieves an information item that is associated with the specified key. In another mode, the IIM also allows a user to store a new information item by identifying a key associated with the information item. The IIM can be implemented as a standalone browser or as a component within an authoring tool. The information items can have any level of granularity.

### BACKGROUND

Browser-based tools provide well-known functionality for accessing information. In a typical scenario, a user may wish to consult a reference source in the course of creating a document. To perform this task, the user may use a browser tool to access an appropriate network-accessible resource. The network resource may provide the desired information within a collection of pages, each page being associated with a distinct network address (e.g., a URL). After obtaining an appropriate page, the user can perform either a manual or automated search to find the desired information within the page. The user then has the option of inserting the identified information into the document that he or she is creating, e.g., using the well-known cut and paste procedure. The user can use similar search tools to access information that is stored by the user's local computer.

Many users have become quite adept at finding information using the above-described procedure. At the same time, this procedure is sometimes cumbersome, inefficient, and unreliable. More generally, there remain unmet challenges in known approaches to interacting with information, and thus ample room for improvement.

### SUMMARY

An information interaction module (IIM) is described for interacting with information items using a hierarchical data structure. The hierarchical data structure includes a plurality of hierarchically-linked nodes represented by respective key elements. Further, the data structure includes information items associated with respective leaf nodes of the data structure. The IIM can use keys to identify respective information items. Each key includes a combination of key elements that “lead to” an information item, starting from a root node and terminating in a particular leaf node that is associated with the information item.

According to another illustrative feature, the IIM includes graphical user interface (GUI) functionality that allows a user to specify a key in guided stepwise fashion. That is, after the user specifies a particular key element, the IIM can provide the user with a set of options regarding one or more subsequent key elements that can be selected by the user. The user continues this selection procedure until the IIM identifies a desired leaf node and its associated information item.

According to another illustrative feature, the IIM can provide the GUI functionality in the form of a standalone browser.

According to another illustrative feature, the IIM can integrate the GUI functionality into an authoring tool or other application. In this case, the user can interact with the IIM without shifting his or her focus away from the authoring tool. In other words, the GUI functionality is configured to work in inline conjunction with the authoring tool.

According to another illustrative feature, the IIM can be used to access information items having any level of granularity. For example, the IIM can be used to access information items on a sub-item level, such as a sub-document level, a sub-page level, etc.

According to another illustrative feature, the IIM can use any type of taxonomy to establish the key elements in the hierarchical data structure. In one case, an individual user can create the taxonomy. In another case, a group of users can create the taxonomy in collaborative fashion. In another case, a network-accessible entity can provide categories of information on which a taxonomy can be based.

According to another illustrative feature, the IIM can allow a user to store new information items associated with identified keys. The IIM performs this task by allowing the user to specify a multi-part key that links to a new information item.

By virtue of the above-summarized illustrative features, the IIM can allow a user to retrieve and store information items in an efficient and flexible manner.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative portion of a data structure that includes hierarchically-linked nodes associated with respective key elements.

FIG. 2 shows illustrative keys that can be constructed to access information items using the type of data structure shown in FIG. 1.

FIG. 3 shows a collection of different data structures that can be constructed based on the type of data structure shown in FIG. 1.

FIGS. 4 and 5 show illustrative graphical user interface (GUI) functionality that can be used to specify a key, which, in turn, can be used to access an information item within the type of data structure shown in FIG. 1; in this context, the GUI functionality can be provided by a standalone browser tool.

FIGS. 6 and 7 show additional illustrative GUI interface functionality that can be used to specify a key; in this context, the GUI functionality can be provided in the context of an authoring tool.

FIGS. 8 and 9 show illustrative GUI functionality that can be used to store an information item within the type of data structure shown in FIG. 1.

FIG. 10 shows a high-level view of functionality that can be used to interact with the type of data structure shown in FIG. 1.

FIG. 11 shows one illustrative system that can implement the functionality of FIG. 10.

FIG. 12 shows one illustrative environment that can implement the system of FIG. 11.

FIG. 13 shows an illustrative procedure for accessing an information item within the type of data structure shown in FIG. 1.

FIG. 14 shows an illustrative procedure in which the procedure of FIG. 13 is used in the context of a standalone browser tool.

FIG. 15 shows an illustrative procedure in which the procedure of FIG. 13 is used in the context of an authoring tool.

FIG. 16 shows an illustrative procedure for storing an information item within the type of data structure shown in FIG. 1.

FIG. 17 shows illustrative processing functionality that can be used to implement any aspect of the features shown in the foregoing drawings.

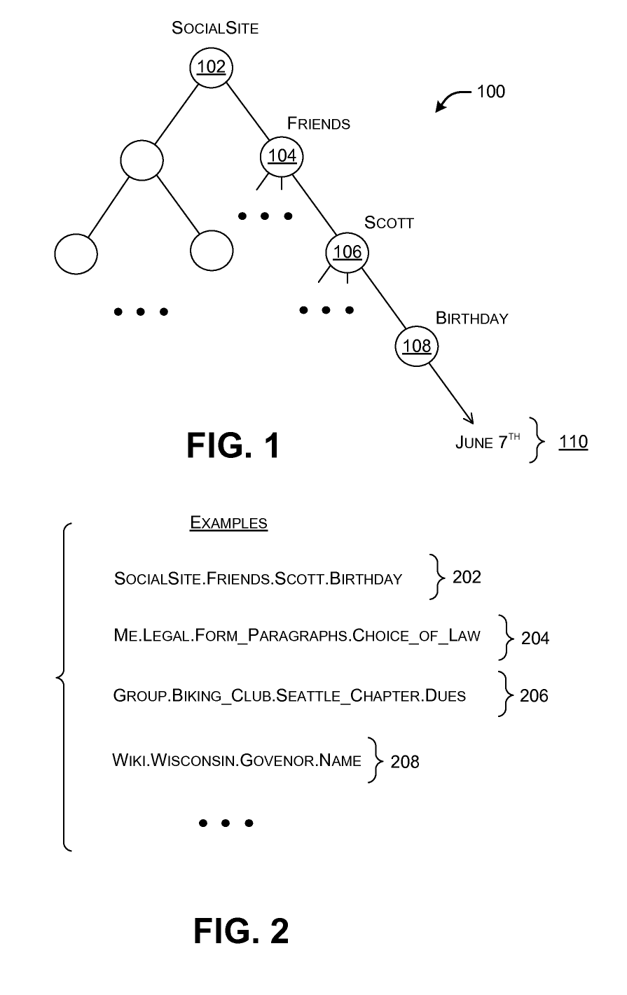

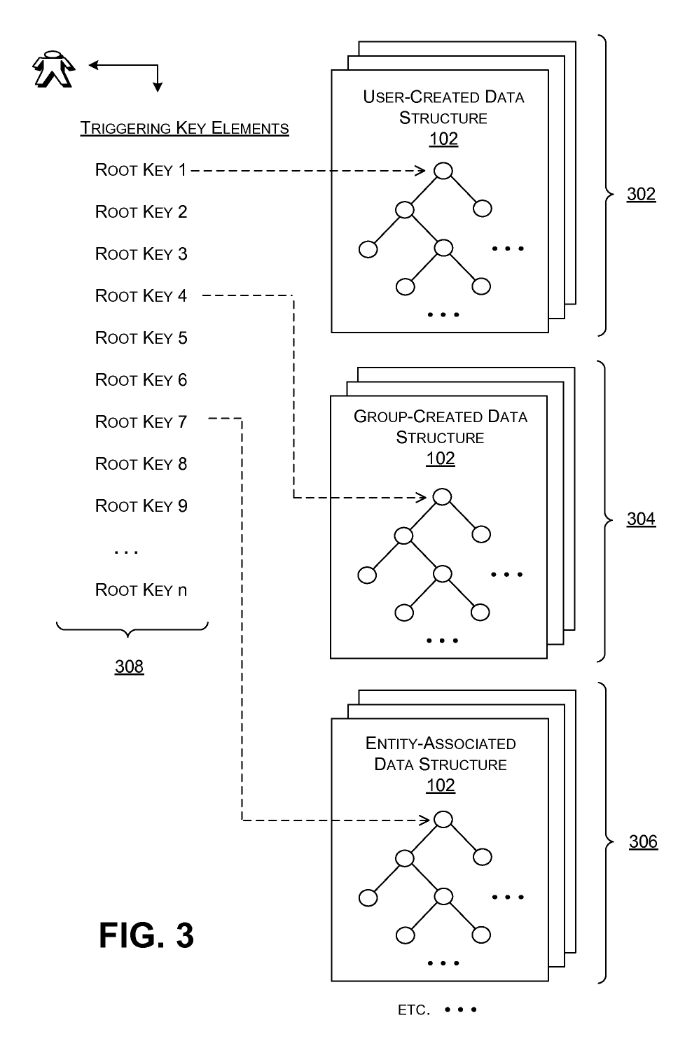

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth illustrative functionality for storing information items in a hierarchical data structure and for retrieving the information items from that data structure. The functionality guides the user in stepwise fashion in entering keys that are associated with the information items.

This disclosure is organized as follows. Section A describes illustrative systems for performing the functions summarized above. Section B describes illustrative methods which explain the operation of the systems of Section A. And Section C describes illustrative processing functionality that can be used to implement any aspect of the features described in Sections A and B.

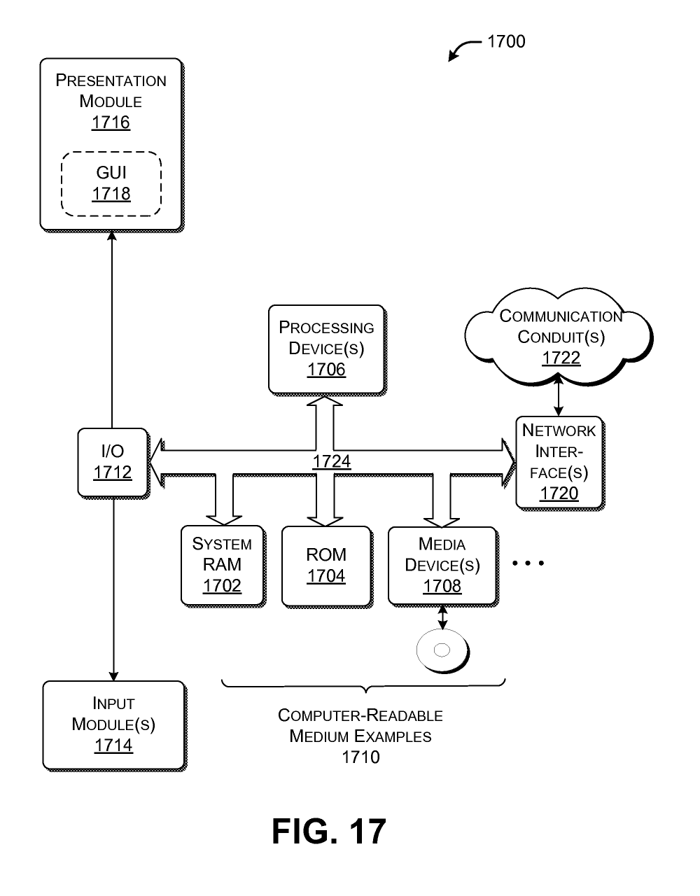

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 17, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

As to terminology, the phrase “configured to” encompasses any way that any kind of functionality can be constructed to perform an identified operation. The term “logic component” encompasses any functionality for performing a task. For instance, each operation illustrated in the flowcharts corresponds to a logic component for performing that operation. When implemented by a computing system, a logic component represents an electrical component that is a physical part of the computing system, however implemented.

A. Illustrative Systems

A.1. Illustrative Hierarchical Data Structure

FIG. 1 shows a portion of an illustrative data structure 100 that can be used to organize information items. As the term is used herein, an information item may correspond to any type of information. For example, an information item can refer to any unit of textual information, image information, audio information, video information, markup language information, code-related information, script-related information, spreadsheet-related information, chart-related information, etc., or any combination thereof. Further, an information item can refer to any unit of information having any level of granularity. For example, in the realm of text information, an information unit can refer to a collection of pages, a single page, a single paragraph, a single sentence, a single word, a single character, and so on.

In one case, an information item may correspond to information that is available from a local source, such as the local storage of a computer device. In another case, an information item may correspond to information that is accessible over a wide area network (such as the Internet) or other type of network. In this case, an information item can optionally correspond to only a part of an item of information that is assigned a discrete network address, e.g., a uniform resource locator (URL). That is, an information item may correspond to a part of a network-accessible document, page, etc.

The data structure 100 comprises a plurality of nodes arranged in hierarchical fashion. That is, the data structure 100 includes a root node, representing a “highest” or most encompassing node in the data structure 100. The root node includes one or more child nodes. Each child node includes none, one, or more of its own respective child nodes. There is no limitation to the number of levels that the data structure 100 may accommodate. A node which contains a child node is referred to as a branch node. A terminal node without any child nodes is referred to as a leaf node. A node per se refers to any type of identifier that represents a position within the data structure 100.

In the approach described herein, an agent of any kind can assign a key element to each node in the data structure 100. For example, as will be discussed, the agent may correspond to a user, a group of users, an application developer, etc. Taken together, the key elements correspond to a taxonomy for classifying information within the realm of one or more subjects. In more technical terms, the key elements can be said to constitute a name space pertaining to an identified subject matter domain. In one case, each key element may correspond to textual information, such as a descriptive phrase, a word, a symbol, etc.

In one merely illustrative case, assume that that a developer or other agent develops a taxonomy based on information provided by a social networking service. That service, for instance, may allow users to create one or more personal pages that provide personal information regarding the users. In this context, the developer can assign key elements to different fields of information provided by the service. The data structure 100 of FIG. 1 corresponds to one such classificatory framework.

In one merely representative case, the data structure 100 assigns a key element “SocialSite” (representing a network-accessible entity that provides the service) to a root node 102. The data structure 100 assigns a key element “friends” (representing friends of a user) to a child node 104. The data structure 100 assigns a key element “Scott” (representing one particular friend) to a child node 106. The data structure 100 assigns a key element “Birthday (representing a birthday of the person Scott) to a child node 108. In this case, the child node 108 represents a terminal leaf node in the data structure 100. Finally, the data structure 100 assigns a particular information item 110 to the child node 108. The information item corresponds to “June 7^{th}”, representing the birthday of the person Scott.

The data structure 100 represents the information item 110 (“June 7^{th}) by a key. The key is composed of those key elements that are traversed in reaching the information item 110, that is, advancing from the root node 102 to the leaf child node 108. Different multi-part keys identify different respective leaf nodes and associated information items.

An information interaction module (IIM), to be described in detail below, stores information items in the data structure 100 and retrieves information items from the data structure 100 using a key-based approach. That is, to store an information item, the IIM constructs a multi-part key that identifies a leaf node with which the information item is to be associated. To retrieve an information item, the IIM specifies a multi-part key that identifies the leaf node with which the information item is already associated. As will be described in detail below, the IIM allows a user to specify a key in piecemeal fashion, one key element at a time. At each stage, the IIM guides the user by identifying a set of subsequent key elements that he or she can choose from.

FIG. 2 shows a series of illustrative keys that can be used to retrieve information items from respective data structures or to store new information items in the data structures. To simplify the explanation, FIG. 2 is set forth in the context of the retrieval of information items from associated data structures. In these cases, the IIM uses a period to separate each pair of successive key elements. This is merely one example; in general, the IIM can use any symbol or convention to represent the separation between key elements.

A first key 202 corresponds to a combination or group of key elements “SocialSite.Friends.Scott.Birthday.” The IIM can use the first key 202 to retrieve the particular information item 110 (“June 7^{th}”) within the data structure 100 of FIG. 1. As stated, the data structure 100 classifies information items provided by a social networking service, as administered by a network-accessible entity. In one scenario, the data structure 100 uses a taxonomy established by a developer or other agent.

A second key 204 concatenates key elements as “Me.Legal.Form_Paragraphs.Choice_of_Law.” The IIM can use the second key 204 to retrieve a particular information item from a user-created data structure (not shown). For example, this data structure can organize form paragraphs that a lawyer uses in writing contracts.

A third key 206 concatenates key elements as “Group.Biking_Club.Seattle_Chapter.Dues.” The IIM can use the third key 206 to retrieve a particular information item within a group-created data structure (not shown). For example, this data structure can organize pieces of information that a biking club frequently accesses, such as information regarding the payment of dues, etc.

A fourth key 208 concatenates key elements as “Wiki.Wisonsin.Govenor.Name.” The IIM can use the fourth key 208 to retrieve a particular item from an encyclopedia source, such as the network-accessible Wikipedia source. This example differs from the above-described data structures in at least one regard. In the above examples, each key element is followed by closed set of child key elements. Upon the specification of a parent key element, the IIM can thus display a list of child key elements from which the user may select. In the present case, the root key element “Wiki” is followed by a potentially vast number of possible second key elements, the key element “Wisconsin” being one such key element. Moreover, the root key element “Wiki” can have child key elements that may vary over time, e.g., as changes are made to the information source. Because the child key elements are potentially dynamic in nature, the nodes associated with these elements can be referred to as dynamic nodes.

In this case, the IIM may refrain from displaying a full set of secondary key elements that follow the root key element “Wiki.” This is because it may be impossible or impracticable to display the full list of possible key elements. Instead, as the user types, the IIM can display a set of key elements which match or resemble the character string input by the user. The IIM can order the candidates in the list based on any criterion or any combination of criteria, e.g., based on a string similarity metric, a term popularity metric, etc. The IIM can improve the relevancy of its list of matching key elements as the user continues to type.

FIG. 3 provides a high-level conceptual view of the manner in which the IIM can interact with one or more data structures to retrieve information items and to store information items. The data structures can be grouped into different categories based on any factor or combination of factors. FIG. 3 categorizes different groups of data structures based on the manner in which they are created.

For instance, one or more data structures 302 pertain to taxonomies defined by individual users. If a user designates a user-created data structure as public, any person can access the data structure. If the user designates a data structure as private, the IIM restricts access to the data structure to designated individuals. One or more other data structures 304 pertain to taxonomies defined by respective groups of users, e.g., in a collaborative fashion. One or more other data structures 306 pertain to taxonomies defined by developers (or other agents) based on information provided by respective network-accessible entities. An example of a network-accessible entity is the social networking service described above with respect to FIG. 1. These groups of data structures are representative of the ways in which different data structures can be established; that is, FIG. 3 is not an exhaustive inventory of the types of data structures that can be defined.

An agent can use any conceptual scheme to organize concepts within a data structure. In one case, the agent assigns different semantic concepts to different nodes, ranging in generality from broad to particular. That is, the agent can assign the broadest category to the root node and the narrowest categories to respective leaf nodes. But an agent can apply other strategies to organize nodes, including an alphabetical schema, a chronological schema, and so on. Furthermore, the agent can combine two or more different classification paradigms within a single data structure. For example, the agent can define a node as “private” or “public.” Such a node may have child nodes that are associated with particular topics. Thus, such a data structure combines status-type nodes (e.g., “private” and “public”) with semantic-type nodes. Labeling a node as private means that any informational content subsumed by this node is only accessible to a particular user or to a particular group of users. Labeling a node as “public” means that any informational content subsumed by this node is accessible to anyone.

FIG. 3 also shows a list 308 of key elements assigned to the root nodes of the corresponding data structures. When a user selects one of these key elements, the user thereby selects a corresponding data structure that is associated with the selected key element. For this reason, these key elements can be referred to as trigging key elements. That is, the selection of any such key element triggers the selection of a corresponding data structure.

A.2. Illustrative Graphical User Interface Functionality

The IIM includes graphical user interface (GUI) functionality that can allow a user to interact with the types of data structures described in Section A.1, such as the data structure 100 described with respect to FIG. 1. The IIM can employ the GUI functionality in at least two contexts. In a first context, the IIM presents the GUI functionality within a standalone browser tool. In a second context, the IIM presents the GUI functionality within an authoring tool or other application. In the latter case, the user may interact with the GUI functionality without losing context with respect to the authoring tool.

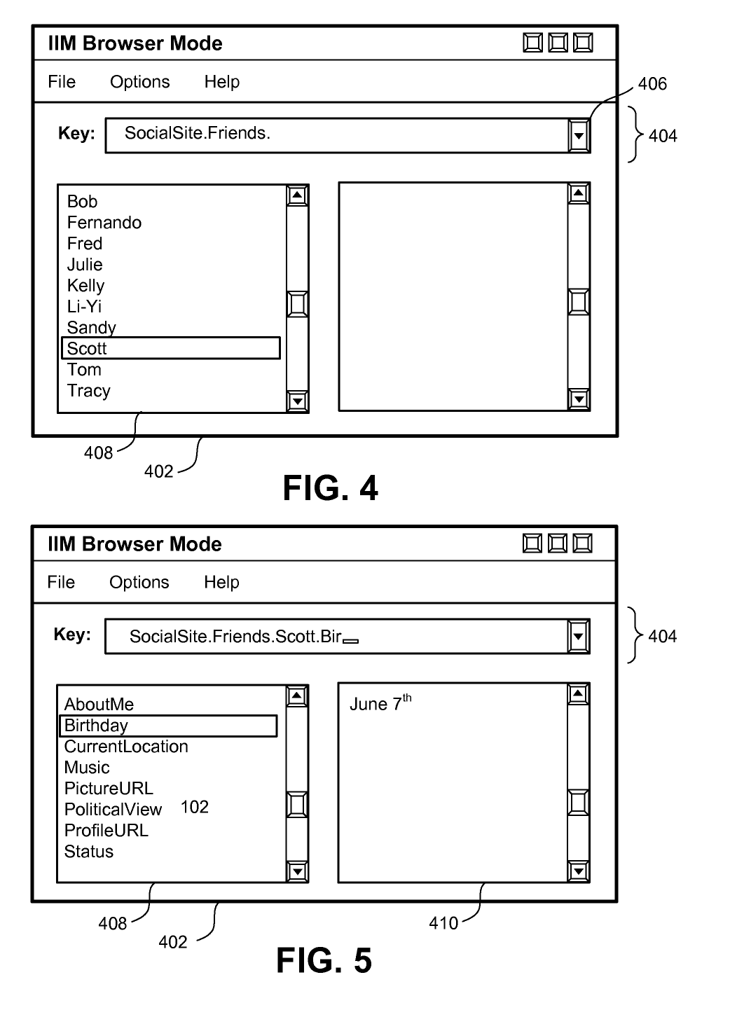

In FIG. 4, the IIM uses the GUI functionality in the first context, e.g., in a standalone browser tool. The GUI functionality produces an illustrative user interface (UI) presentation 402. This UI presentation 402 is one of many types of presentations that can be produced. Other UI presentations can provide different UI features, different arrangements of UI features, different UI styles, and so forth.

The UI presentation 402 is described in the context of the retrieval of an information item that has already been associated with a particular node in a data structure. More specifically, in the illustrated scenario, the goal of the IIM is to retrieve the information item 110 within the data structure 100 of FIG. 1.

The UI presentation 402 includes a text input section 404. The IIM uses the text input section 404 to create the key (“SocialSite.Friends.Scott.Birthday”) in piecemeal fashion. This is the key that will be used to access the desired information item 110, i.e., “June 7^{th}.” The text input section 404 can include a drop-down menu button 406. Upon activation of this menu button 406, the IIM displays a list of root key elements associated with different data structures. In this case, the user will wish to select the key element “SocialSite” which corresponds to the data structure 100. Alternatively, if remembered, the user may directly type the root key element “SocialSite” into the text input section 404. The IIM can also assist the user by automatically filling in the remainder of the text associated with the root key element as the user types out the root key element. For instance, when the user types “Soc,” the IIM can determine the root key element that the user is typing and fill in the remainder of the text, namely “SocialSite.” Each key element that the user selects is added to a group of selected key elements.

An option section 408 displays a set of options associated with key elements which the user may select from next. Assume, for example, that the user has already specified two key elements of the complete key, namely “SocialSite” and “Friends.” Upon typing the period at the end of “Friends,” the IIM can present a list of key elements in the option section 408, any of which the user can select from next. Here, the list of options identifies the user's friends. These friends correspond to child nodes associated with the parent key element “Friends.”

The user may select one of the designated options in different ways. In one approach, the user may manually select one of the options that are displayed in the option section 408, e.g., using a mouse-type input device or the like. In another approach, the user may begin to type one of the displayed options, such as by typing the characters “Sc.” The IIM can then highlight the entry “Scott” which matches the initial letters typed by the user. The user can then select the highlighted option, e.g., by clicking on it, pressing a designated key on a key input device (such as the space bar or the enter key on a keyboard), and so forth. Alternatively, or in addition, the IIM can automatically fill in the remainder of the key element based on the initial letters typed by the user. The IIM can employ yet other input strategies to receive the selection of a subsequent key element from the user.

The above-described process can be repeated one or more times. As shown in FIG. 5, after selecting the friend key element “Scott,” the user advances to the task of selecting the leaf node element. In this case, the user begins to type “Birthday,” upon which the IIM highlights a corresponding key element in the option section 408. The user may formally select this key element (i.e., “Birthday”) in any of the ways described above.

At this juncture, the IIM has resolved the information item that the user is attempting to access, since the key item “Birthday” is a terminal leaf node. In response, the IIM can display the information item (“June 7^{th}”) in an item presentation section 410. Further, the IIM can copy this information item into the user's clipboard. This allows the user to paste the information item into any document that he or she happens to be creating, for instance.

As mentioned above with respect to FIG. 2, in certain cases, the IIM may not be able to present a manageable number of subsequent options within the option section 408. For example, assume that the user selects the root key element “Wiki.” As explained, the IIM can identify a potentially large number of possible key elements which could follow the root key element. In the manner described above, the option section 408 can display matching options to the user as the user types out the subsequent key element. In some cases, the user may attempt to enter a key element that is not recognized by the IIM. The user can address this situation by deleting text that he or she has typed. The user may then type in another key element in hopes of finding a recognized key element.

More generally, the IIM can allow the user to backtrack by deleting one or more key elements from the text input section 404. For example, the user can delete the key elements “Scott” and “Birthday,” upon which the IIM again presents the user with the options displayed in the option section 408 of FIG. 4.

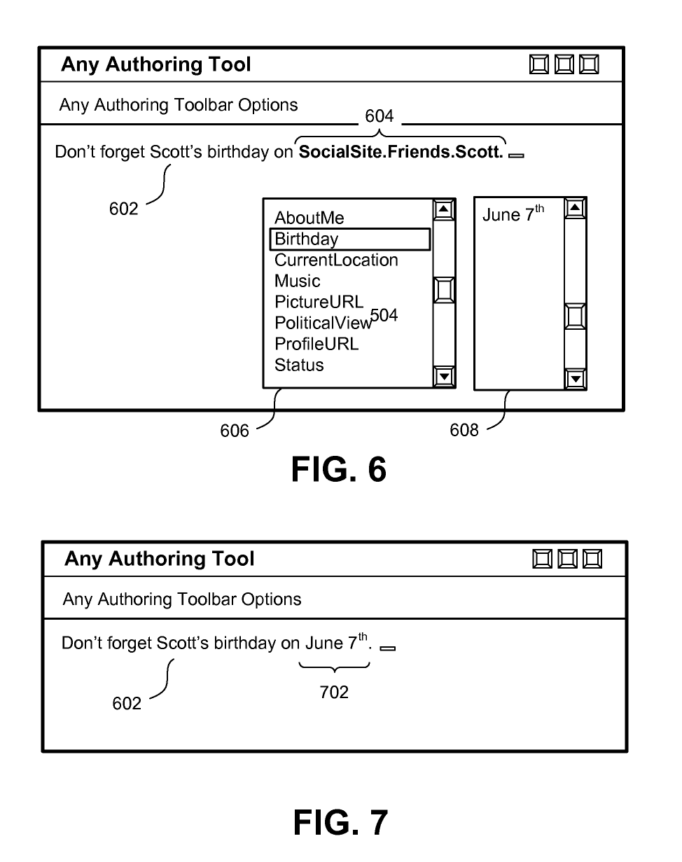

FIG. 6 shows a case in which the IIM employs the GUI functionality in the context of an authoring tool, such as a document-creation application, a message-creation application (e.g., an Email application, an instant-messaging application, etc.), and so on. No limitation is placed on the type of application in which the GUI functionality can be integrated.

In the particular scenario of FIG. 6, the user is typing the sentence “Don't forget Scott's birthday on . . . ,” as represented by input text 602. At this juncture, the user wishes to access a data structure which provides the birth date of the person named Scott. To invoke the appropriate data structure, the user may begin to type the name of the corresponding root key element, namely “SocialSite.” The IIM can then assist the user in completing the root key element in any manner described above. In one implementation, the root key elements can begin with a character that is not commonly used in creating a message, such as an asterisk (*). The IIM can apply this provision to help determine whether the user is attempting to invoke the IIM or whether the user is simply typing a normal word in the message.

After the user has selected the root key element, the IIM next guides the user in specifying a complete key 604 that leads to the desired information item in the manner described above. Namely, the IIM presents an option section 606 which presents a set of options pertaining to key elements which the user may select from next. Upon reaching the leaf node, the IIM presents the desired information item in an item presentation section 608.

FIG. 7 shows an ultimate result upon identifying the desired information item, “June 7^{th}.” Namely, the IIM replaces the key 604 (of FIG. 6) with the desired information item 702, “June 7^{th}.” Note that the user can continue to focus on the authoring task at hand while interacting with the IIM. In other words, the scenario shown in FIGS. 6 and 7 does not involve switching contexts between a document authoring task and an information retrieval task; the two tasks are integrated together.

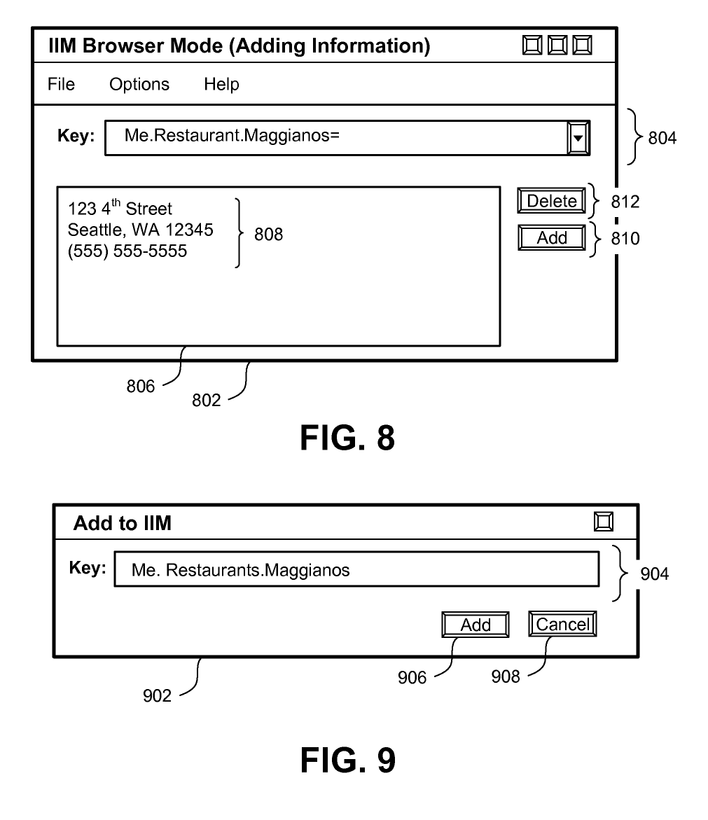

FIG. 8 shows a case in which the IIM can be used to associate a new information item with an identified key. In other words, in this context, the IIM associates a new information item with a leaf node of a data structure. In FIG. 8, the IIM performs this function using a standalone browser tool. The IIM presents a UI presentation 802 which accomplishes this task.

The UI presentation 802 includes a text input section 804 which allows the user to specify the key associated with the new information item. The user can specify the key in the piecemeal manner described above. That is, at each stage, the IIM can guide the user with respect to a set of key elements that can be selected.

In the illustrated scenario, the user enters the illustrative key “Me.Restaurants.Maggianos” into the text input section 804. This key identifies a leaf node in a user-generated data structure. The leaf node is associated with a particular restaurant known to the user. At this juncture, assume that the user wishes to add an information item to the leaf node that provides the address of the restaurant. To perform this task, the user can type a designated shortcut code at the end of the key, such as the character “=”. The IIM interprets this character as an indication that the user wishes to add an information item to the leaf node. In response, the IIM can present an item input section 806 which accommodates the input of an information item 808, in this case, the address of the restaurant. For example, the user can manually type the information item 808, or add the information item 808 using a cut and paste procedure, and so on.

The user can activate an add button 8 10 to formally add the information item 808 to the data structure. This action adds a new information item to the leaf node. Alternatively, in the case in which the leaf node already contains an information item, this action replaces the existing information item with the new information item. The user can activate a delete button 812 to delete an information item that has been previously added to the data structure. The user can also delete an information item by typing a shortcut character (such as a minus sign) in the text input section 804. These specific command features are merely representative; other command features can be used to accomplish the same actions.

FIG. 9 shows a UI presentation 902 that allows the user to add an information item by first selecting the information item (e.g., before entering the key associated with the information item in the manner described above in connection with FIG. 8). For example, the user may be in the process of creating or viewing a document. The user may encounter a piece of text, image, or other piece of data that he or she wishes to add to a designated node in a data structure. In response, the user can select the information item using any appropriate mechanism (not shown), such as a text copying mechanism. The user can then activate an appropriate command to add the selected information item to a data structure. This command invokes the UI presentation 902.

The UI presentation 902 includes a text input section 904 for specifying the key of the new information item. Again, although not shown, the IIM can guide the user in entering this key in the stepwise manner described above. The UI presentation 902 includes an add button 906 to formally add the information item to the data structure. The UI presentation 902 includes a cancel button 908 to cancel the data-setting operation.

Although not heretofore mentioned, a user may occasionally interact with a data structure that includes various access restrictions. In these cases, the IIM can ask the user to provide appropriate credentials before allowing the user to interact with the data structure.

A.3. Information Interaction Module (IIM) and Associated Environment

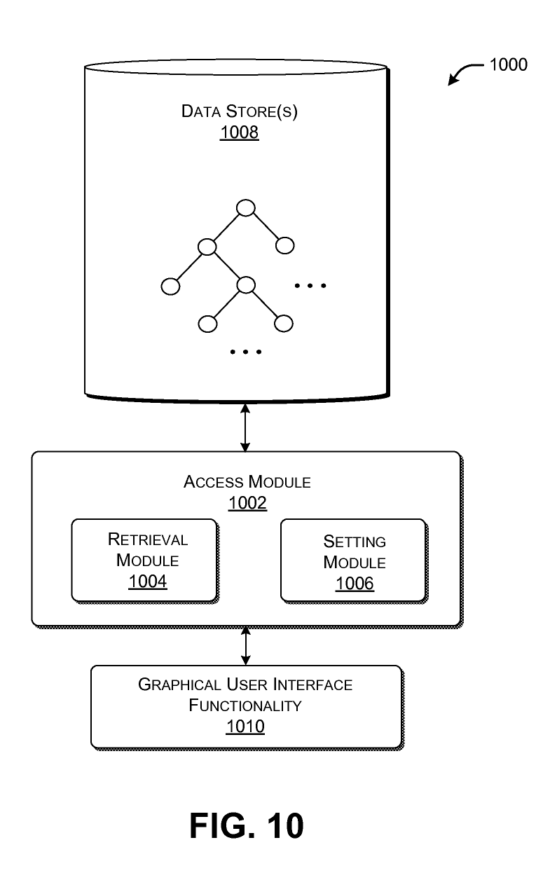

FIG. 10 shows a high-level overview of functionality 1000 associated with an information interaction module (IIM). In one case, all of the functionality 1000 is implemented by the IIM. In another case, a subset of the functionality 1000 is implemented by the IIM. Generally, the demarcation of the functionality 1000 in FIG. 10 is presented to explain the operation of the IIM in a structured manner; in some implementations, there may be an overlap of functions performed by the various components shown in FIG. 10.

The functionality 1000 includes an access module 1002 for interacting with information items through one or more data structures. Namely, the access module 1002 performs two core tasks: retrieving information items and setting information items. These core tasks can be implemented by two respective modules (or can be conceptualized as two respective modules). Namely, a retrieval module 1004 performs the task of accessing information items from one or more data structures. A setting module 1006 performs the task of storing information items in one or more data structures.

FIG. 10 indicates that the data structures can be persisted in one or more data stores 1008. More specifically, each data structure includes two kinds of data. A first class of data corresponds to information which describes the node structure of the data structure, along with the key elements which are associated with respective nodes. A second class of data corresponds to information items that are associated with the nodes of the data structure, e.g., the leaf nodes of the data structure.

In one mode of operation, the functionality 1000 can represent a data structure as a collection of hierarchically-linked XML elements. For example, assume that the user creates a node associated with his or her user name, such as a “tech_lover.” The user or other agent can create this node, along with a collection of four child nodes using the following XML information:

```
<node id = “tech_lover” >
    <node id = “public” />
    <node id = “faves” />
    <node id = “articles” />
    <node id = “work” />
</node>
```

The user or other agent can create two child nodes (“msn_money” and “cnn”) which depend on the node “faves” as follows:

```
<node id = “faves”>
    <node id = “msn_money” type = “text/plain” />
    <node id = “cnn” type = “text/plain” />
</node>
```

In this excerpt, the “msn_money” node and the “cnn” node can accommodate information items. For example, a user or agent can store network addresses associated with the nodes “msn_money” and “cnn.”

FIG. 10 also broadly represents graphical user interface (GUI) functionality 1010 that provides the UI presentations described in Section A.2. The GUI functionality 1010 allows a user to interact with the access module 1002.

In one case, the access module 1002 supports a number of functions that allow it to interact with the data structures. For example, the access module 1002 may support: a function to retrieve child nodes associated with an identified node; a function to retrieve a node object associated with a particular node; a function to retrieve content associated with a particular node (if the node includes an information item); a function to update content associated with a particular node; a function to cancel a retrieval operation that is currently in progress; and a function to invoke a request pending status when a request is in progress, but, for instance, where that request may be dependent on input of some type from the user. These functions are illustrative, rather than exhaustive; other implementations can provide other sets of functions.

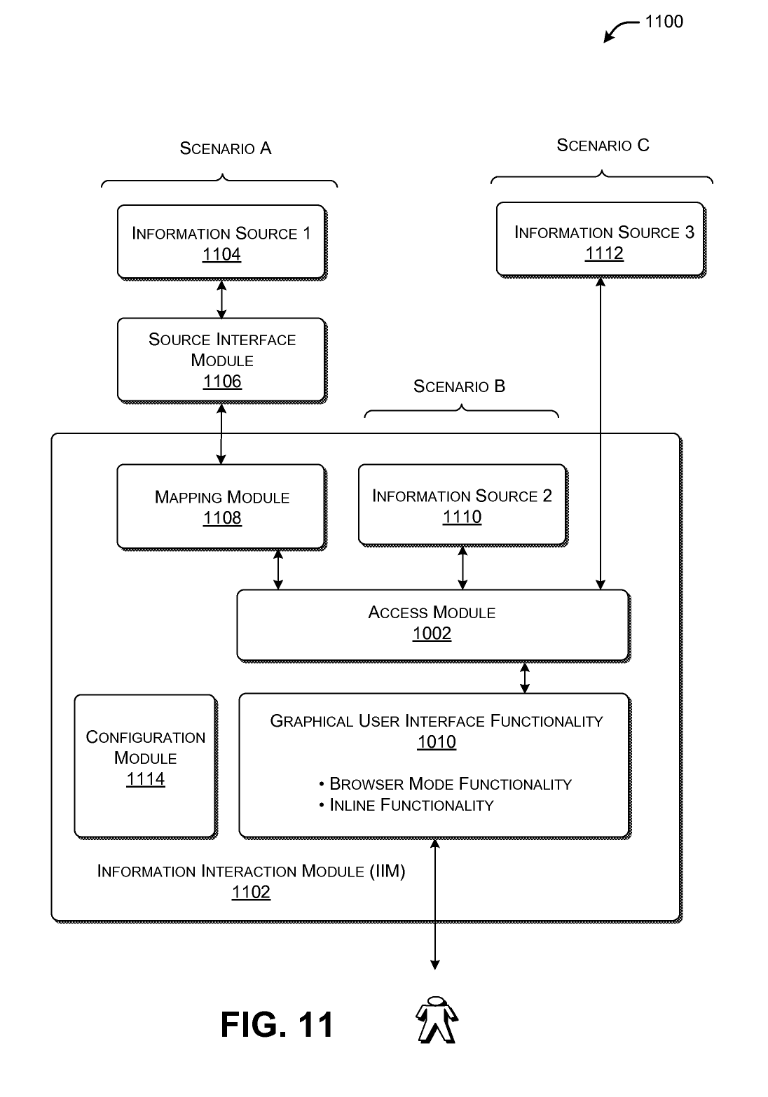

FIG. 11 shows one illustrative system 1100 that can implement one version of an information interaction module (IIM) 1102. In this case, the IIM 1102 shows the access module 1002 and the GUI functionality 1010 described above. To repeat, the access module 1002 allows the IIM 1102 to interact with one or more data structures. The GUI functionality 1010 delivers the type of UI presentations described above in Section A.2. More specifically, the IIM 1102 can provide the UI presentations in the context of a standalone browser tool. In another case, the IIM 1102 can provide the UI presentations in the integrated context of any type of authorizing tool or other application.

The system 1100 can implement the various functions described above in different ways for different respective implementations. FIG. 11 represents three possible scenarios for implementing these features. These implementations are representative, rather than exhaustive; that is, the system 1100 can accommodate yet additional scenarios.

In a scenario A, the IIM 1102 relies, at least in part, on an external information source 1104 to provide the data structure, e.g., to provide information that can be used to constitute the data structure. The information source 1104 may represent computing functionality provided by a network-accessible entity, such as a social networking service or the like. The information source 1104 supplies any type of information that can be used to provide the data structure. For example, the information source 1104 can provide data that can be used to populate the nodes in the data structure. For example, the information source 1104 can provide category information that can be mapped into key elements associated with respective nodes. In addition, or alternatively, the information source 1104 can provide data that can be used to define the information items provided by the data structure. For example, the information source 1104 can be used to provide the birth date of the person named Scott in the example of FIG. 1.

A source interface module 1106 represents functionality that the information source 1104 uses to interact with other entities. For example, in one case, the source interface module 1106 can represent any kind of web service functionality. One type of web service functionality can use a REST-type interface (where REST is an acronym for “reStructuredText”). Another type of web service functionality can use a SOAP-type interface (where SOAP is an acronym for “Simple Object Access Protocol”). Alternatively, or in addition, the source interface module 1106 can represent any type of feed-type interface, such as an RSS-type feed (where RSS is an acronym for “Really Simple Syndication”). Alternatively, or in addition, the source interface module 1106 can represent a web-type interface that is accessible to browser-based tools. No limitations placed on the nature of the source interface module 1106 that can be used by the information source 1104 to convey information to the IIM 1102.

The IIM 1102 can employ a mapping module 1108 for interacting with the information source 1104 via the source interface module 1106. The mapping module 1108 can apply functionality that complements the functionality used by the source interface module 1106. For example, the mapping module 1108 can use web service functionality to interact with like web service functionality employed by the source interface module 1106. In another case, the mapping module 1108 can apply a feed-type extraction tool to interact with an RSS feed provided by the source interface module 1106. In another example, the mapping module 1108 can apply screen scraping functionality for extracting information from web pages provided by the source information module 1106, and so on.

The mapping module 1108 can also perform a mapping function. That is, in one case, the IIM 1102 can establish a data structure that uses a first scheme to represent information items. Yet the information source 1104 may organize information using a second scheme. For example, the information source 1104 may not organize information in any hierarchical fashion. Or if it does organize information in this way, it may use a different taxonomy compared to the taxonomy expected by the IIM 1102. In this case, a developer or other agent can configure the mapping module 1108 to map (e.g., translate) information received from the information source 1104 to a form that it suitable for use by the IIM 1102.

Scenario A has been explained in the context of a single group of modules—that is, the information source 1104, the source interface module 1106, and the mapping module 1108. However, the system 1100 can include additional groups of modules, thereby enabling the IIM 1102 to interact with additional external information sources. For example, the IIM 1102 can employ a second mapping module (not shown) that is configured to interact with another type of external information source (not shown).

Moreover, in the examples described above for scenario A, the information source 1104 represents an external entity with respect to the IIM 1102. But in another case, the information source 1104 can represent a local resource with respect to the IIM 1102. For example, the information source 1104 may represent a file system provided by a local computer. The source interface module 1106 and the mapping module 1108 interact with this local resource in the manner described above, except that the information source 1104 is local with respect to the IIM 1102.

Given the above explanation, in scenario A, the data structure can be said to “reside” in different parts of the system 1100. In one case, the IIM 1102 can request information from the information source 1104 on an on-demand basis, e.g., when a user makes a request for this information. As explained above, the mapping module 1108 can translate any of the information provided by the information source 1104 to suit the key element taxonomy employed by the IIM 1102. In this case, the data structure can be said to be constituted through the combined information provided at both the information source 1104 and the IIM 1102. In another case, the IIM 1102 can interact with the information source 1104 to update a local copy of the data structure on a periodic basis or any other basis (e.g., using a push technique, a pull technique, or any other technique or combination of techniques).

Scenario B represents a situation in which the access module 1002 can directly interact with an information source 1110. In other words, the IIM 1102 can interact with the information source 1110 without the interfacing and translation operations performed by the mapping module 1108 (of scenario A). In this scenario, the data structure can be said to be entirely (or substantially entirely) implemented by the information source 1110 itself. In scenario B, the information source 1110 is local with respect to the IIM 1102.

Scenario C is the same as scenario B except that the access module 1002 interacts with an information source 1112 that is provided at a remote location with respect to the IIM 1102. In other words, the IIM 1102 can interact with the information source 1112 without at least the translation operations performed by the mapping module 1108 (of scenario A). In one implementation, the information sources (1110, 1112) of scenarios B and C can be implemented as REST-type services. These services can use a hierarchical taxonomy defined by the user or other agent.

The mapping module 1108 and the information sources (1110, 1112) can be configured as plug-in units to support an extensible IIM model. For example, a user, developer, or other agent can add a new mapping module and/or information source to accommodate a new data structure. Further, a user, developer, or other agent can remove an existing mapping module and/or information source, or can replace an existing mapping module and/or information source with another mapping module and/or information source. In one approach, an agent develops a new mapping module and/or information source so that it conforms to an interface standard specified by the IIM 1102. This ensures compatibility of the new mapping module and/or information source with the IIM 1102.

A configuration module 1114 can be used to set up any aspect of the operation of the IIM 1102 to function in the manner described above. For example, the configuration module 1114 can be used to define a taxonomy which establishes the key elements associated with the data structure. In addition, or alternatively, the configuration module 1114 can be used to define the location at which the data structure can be found. In addition, or alternatively, the configuration module 1114 can be used to define the root key element associated with each data structure that the IIM 1102 has access to. In addition, or alternatively, the configuration module 1114 can be used to identify the nature of the processing performed by the mapping module 1108 or other component of the IIM 1102. In addition, or alternatively, the configuration module 1114 can be used to store authentication information that allows prescribed users to interact with external information sources. The configuration module 1114 can perform yet other functions relating to the setup of the IIM 1102.

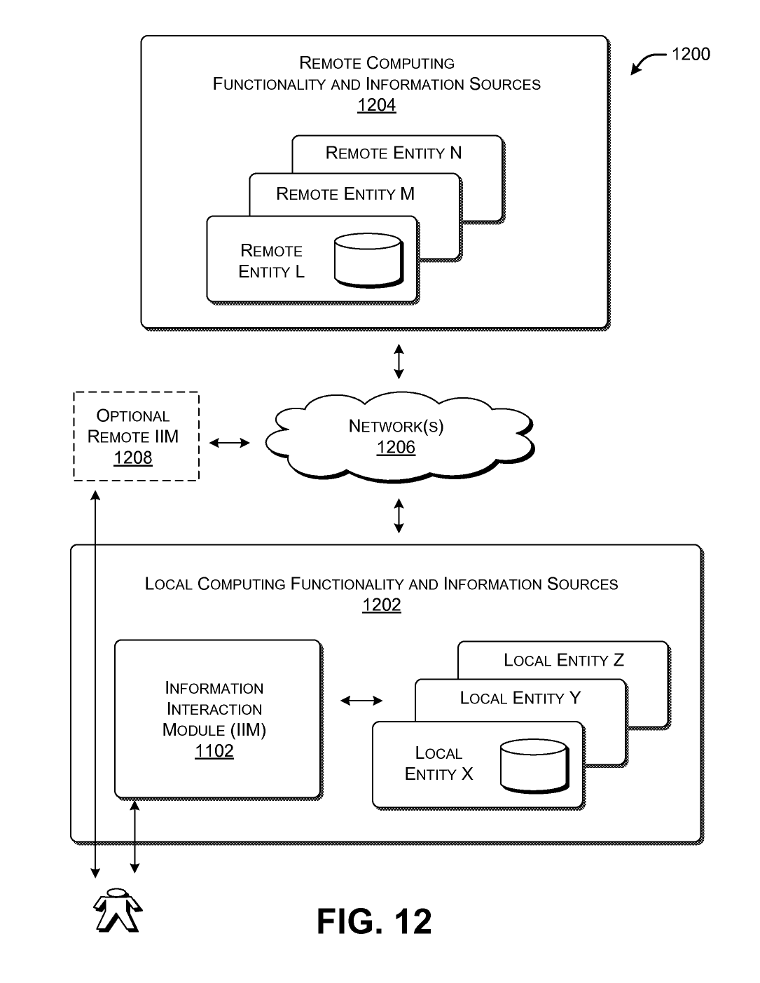

FIG. 12 shows an environment 1200 that can implement the system of FIG. 11. In this figure, the IIM 1102 can be implemented by local computing functionality and information sources 1202. Such local resources can include the representative local entity X, local entity Y, and local entity Z, etc. For example, local entity X may represent a file system that can be accessed to provide information used to populate the data structure.

The IIM 1102 may also (or alternatively) interact with remote computing functionality and information sources 1204 via a network (or networks) 1206. Such remote resources can include the representative remote entity L, remote entity M, and remote entity N, etc. For example, the remote entity L may correspond to a network-accessible entity that implements a service of any type.

The local computing functionality and information sources 1202 may correspond to any type of computing device, such as a personal desktop computing device, a laptop computing device, a personal digital assistant (PDA) computing device, a stylus-type computing device, a mobile phone computing device, and so on. The remote computing functionality and information sources 1204 can represent any type of remote processing infrastructure, such as one or more server-type computers in cooperation with one or more data stores (and potentially other types of data processing equipment). The remote resources can be provided at a single location or can be distributed over plural locations. The network 1206 (referred to in the singular for brevity) can represent a local area network, a wide area network (e.g., the Internet), or some combination thereof.

In the examples discussed thus far, the IIM 1102 is implemented as a local resource by the local computing functionality and information sources 1202. In another implementation, the user can use a local computing device to interact with a remote IIM 1208, which may correspond to a network-accessible service which provides the IIM-type functions described above. In this implementation, the remote IIM 1208 can act as a go-between that interacts with both the user and one or more remote information sources.

A.4. Illustrative Variations

The systems described above can be varied in different ways. In a first variation, the IIM can include functionality which allows a user to advance to a node or a desired information item without necessarily sequencing through each key element along the way. For example, if the user types a key element which is not an immediate child node (but is nevertheless a descendent node), the IIM can allow the user to directly interact with that node. The IIM can optionally automatically fill in intermediary key elements that have been “skipped over.”

In a second variation, the IIM can allow the user to search across nodes in different branches of the hierarchical data structure. That is, the IIM can allow the user to search “sideways” across a data structure. In additional, or alternatively, the IIM can allow the user to search for matching key elements in ancestor nodes with respect to a current position within a data structure. In this sense, the IIM can allow the user to search backward through the data structure (towards the root node) as well as forward (towards the leaf nodes).

In a third variation, the IIM can provide various ways of visualizing a data structure or parts thereof. For example, the IIM can display a representation of a tree; further, the IIM can display the key elements associated with the nodes of the tree. This feature can help guide the user in the entry of key elements.

In a fourth variation, the IIM can allow any data structure to reference two or more separate information sources, instead of a single information source. For example, a particular mapping module can be configured to interact with two remote information sources, or a remote information source in combination with a local information source.

In a fifth variation, the IIM can allow a user or other agent to establish a node that acts as a link to another node. That other node can be located in the same data structure or another data structure. Using this mechanism, an agent can create a data structure which makes reference to another data structure (possibly provided by a different agent).

In a sixth variation, the IIM can allow the user or other agent to establish two keys that point to the same information item without necessarily duplicating the information item. For example, the user can establish two keys which link to an information item about a football team through two respective paths. A first path may pertain to a sports theme, while a second path may pertain to a host city theme.

In a seventh variation, the IIM can accommodate a free-form search. For example, the IIM can accommodate a key “Search.<search term>.” The root key element (“Search”) indicates that this key is associated with a general search operation. The second dynamic key element (“<search>”) indicates the user may input any key term. Based on this key term, the IIM performs a general search operation, potentially with respect to a large number of information sources.

According to an eighth variation, a user can freely enable and disable the IIM, especially in the context of its inline mode of operation. This prevents the IIM from interrupting the work of a user who does not wish to utilize this service.

The IIM can accommodate yet other variations and additional features. The above examples are representative, rather than exhaustive.

B. Illustrative Processes

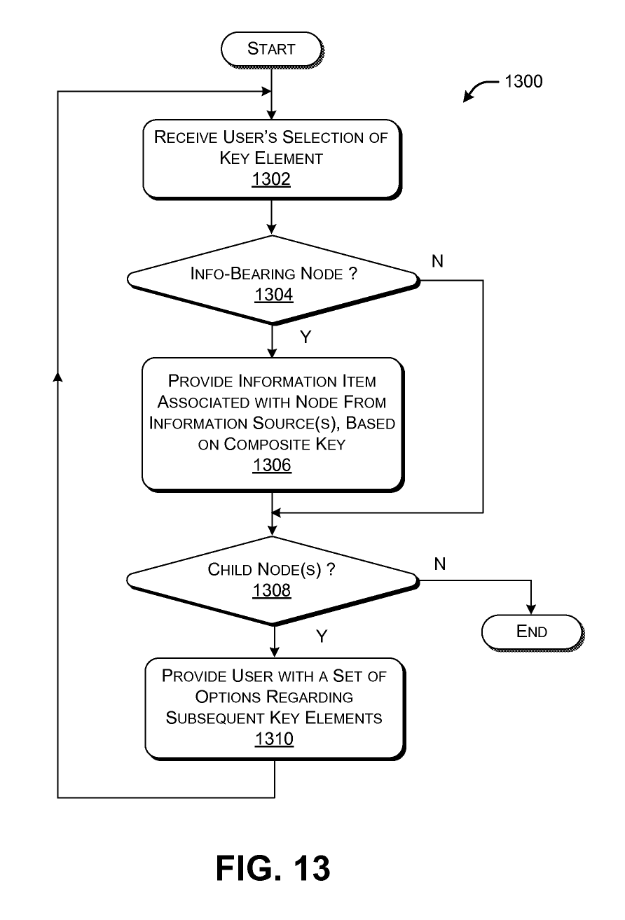

FIGS. 13-16 explain the operation of the systems described above in flowchart form. Since the principles underlying the operation of the systems have already been described in Section A, certain operations will be addressed in summary fashion in this section.

Starting with FIG. 13, this figure shows a procedure 1300 for retrieving information from a data structure.

In block 1302, the IIM receives the user's selection of a key element. For instance, upon a first iteration of this procedure 1300, the IIM receives the user's selection of a root key element of a desired data structure.

In block 1304, the IIM determines whether the node associated with the identified key element is an information-bearing node—that is, a node which links to an information item. In one case, only leaf nodes have the potential of linking to information items. But in other cases, branch nodes can also potentially link to information items.

In block 1306, if block 1304 is answered in the affirmative, then the IIM provides the information item associated with the identified node. The IIM retrieves the information item based on the composite key that is constructed based on successively-specified key elements.

In block 1308, the IIM determines whether the node associated with the last-specified key element has child nodes.

In block 1310, if block 1308 is answered in the affirmative, then the IIM provides the users with a set of options regarding key elements that can be selected next. For example, a standalone browser tool can provide these choices in its option section 606.

The procedure 1300 then returns to block 1302, upon which the IIM receives another key element selection from the user. This procedure continues until the desired information item is provided.

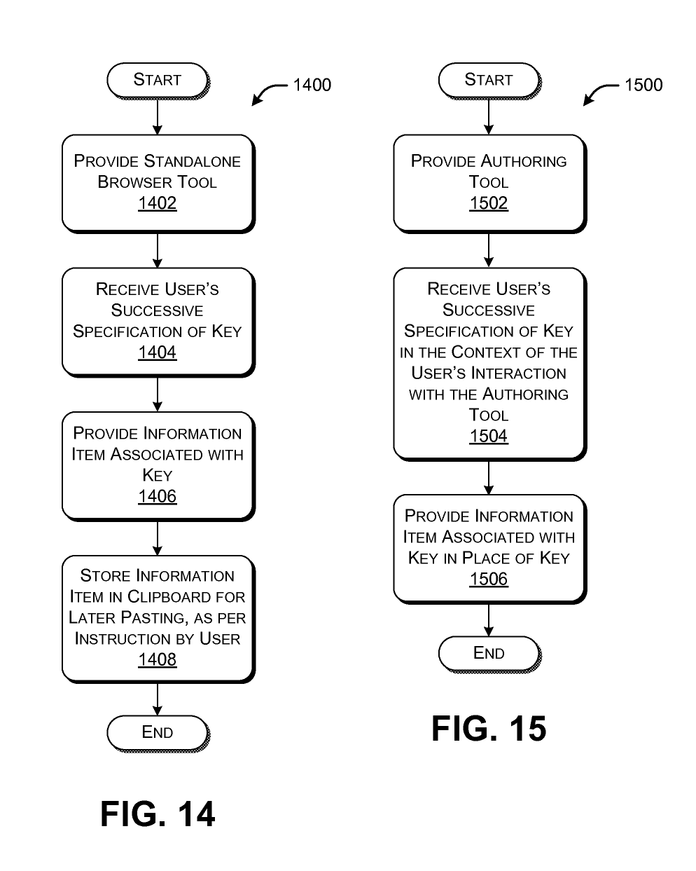

FIG. 14 describes a procedure 1400 for implementing procedure 1300 in the context of a standalone browser tool.

In block 1402, the IIM provides the standalone browser tool.

In block 1404, the IIM receives the user's successive selection of key elements in the manner describe above with respect to FIG. 13.

In block 1406, the IIM provides a desired information item based on a key specified as per block 1404.

In block 1408, the IIM stores the information item, allowing it to be pasted into a document or the like.

FIG. 15 describes a procedure 1500 for implementing the procedure 1300 in the context of an authoring tool or other application.

In block 1502, computing functionality provides an authoring tool, such as document-creation application, a message-creation application, etc.

In block 1504, the IIM receives the user's successive selection of a key in the context of the user's interaction with the authoring tool and without removing the user's focus from the authoring tool.

In block 1506, the IIM provides an information item in place of the key created in block 1504.

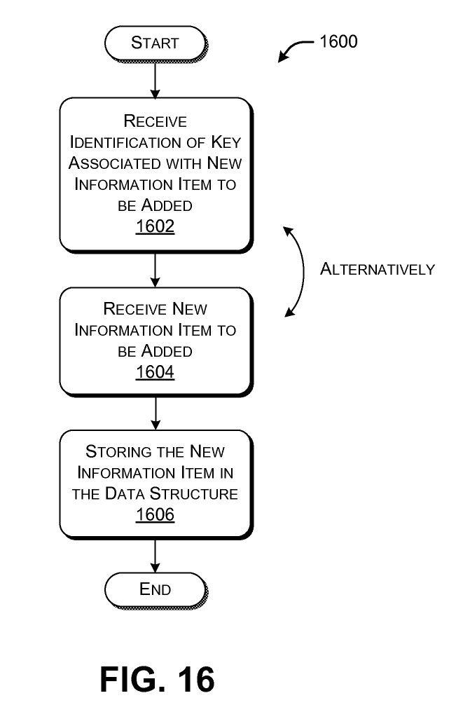

FIG. 16 describes a procedure 1600 for storing an information item in a data structure, either in a standalone browser mode of operation or an inline mode of operation.

In block 1602, the IIM receives an identification of a key associated with a new information item to be added to the data structure.

In block 1604, the IIM receives the new information item itself. FIG. 16 indicates that the order of blocks 1602 and 1604 can be reversed. In that case, the user can first specify the new information item, and then specify the key associated with the information item.

In block 1606, the IIM associates the new information item with the identified key, thereby linking the new information item to the data structure. In other words, the IIM stores the new information item in the data structure.

C. Representative Processing Functionality

FIG. 17 sets forth illustrative electrical data processing functionality 1700 that can be used to implement any aspect of the functions described above. With reference to FIGS. 11 and 12, for instance, the type of processing functionality 1700 shown in FIG. 17 can be used to implement any aspect of the functionality 1000 of FIG. 10, the system 1100 of FIG. 11, and/or the environment 1200 of FIG. 12. In one case, the processing functionality 1700 may correspond to any type of computing device or electrical apparatus that includes one or more processing devices.

The processing functionality 1700 can include volatile and non-volatile memory, such as RAM 1702 and ROM 1704, as well as one or more processing devices 1706. The processing functionality 1700 also optionally includes various media devices 1708, such as a hard disk module, an optical disk module, and so forth. The processing functionality 1700 can perform various operations identified above when the processing device(s) 1706 executes instructions that are maintained by memory (e.g., RAM 1702, ROM 1704, or elsewhere). More generally, instructions and other information can be stored on any computer readable medium 1710, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 1700 also includes an input/output module 1712 for receiving various inputs from a user (via input modules 1714), and for providing various outputs to the user (via output modules). One particular output mechanism may include a presentation module 1716 and an associated graphical user interface (GUI) 1718. The processing functionality 1700 can also include one or more network interfaces 1720 for exchanging data with other devices via one or more communication conduits 1722. One or more communication buses 1724 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented by an electrical apparatus for accessing an information item, comprising:
receiving a user's selection of a key element, the key element that is selected being added to a group of selected key elements;
providing the user with a set of options regarding one or more subsequent key elements that are selectable by the user;
receiving the user's selection of a subsequent key element selected from among said one or more subsequent key elements, the subsequent key element that is selected being added to the group of selected key elements;
providing the user with an information item that is associated with the subsequent key element, if an information item is associated with the subsequent key element; and
providing the user with another set of options regarding a next level of one or more subsequent key elements, if the next level exists,
the method being implemented using graphical user interface functionality provided by the electrical apparatus,
the information item being accessed from a store based on a key, the key being composed of the group key elements.

2. The method of claim 1, wherein the method accesses the information item using a hierarchical data structure that includes a plurality of hierarchically-linked nodes, wherein the nodes are associated with respective key elements.

3. The method of claim 2, wherein the respective key elements are defined by the user.

4. The method of claim 2, wherein the respective key elements are defined in collaborative fashion by a group of users.

5. The method of claim 2, wherein the respective key elements are associated with categories of information items provided by a network-accessible entity.

6. The method of claim 1, wherein the user interacts with the graphical user interface functionality as a standalone browser tool.

7. The method of claim 1, wherein the user interacts with the graphical user interface functionality in a course of interacting with an authoring tool, without a change of context.

8. The method of claim 7, wherein the authoring tool is a document-creation application.

9. The method of claim 7, wherein the authoring tool is a message-creation application.

10. The method of claim 1, further comprising:
receiving a selection of an identified key at which to access a new information item;
receiving the new information item; and
storing the new information item in the hierarchical data structure at a location associated with the identified key.

11. An information interaction module for interacting with information items, comprising:
graphical user interface functionality configured to receive a user's selection of a key through the user's successive selection of plural key elements which compose the key; and
an access module configured to use the key to store or retrieve an information item associated with the key,
the access module being configured to store or retrieve the information item using a hierarchical data structure that includes a plurality of hierarchically-linked nodes, the nodes being associated with respective key elements.

12. The information interaction module of claim 11, wherein at least one information item stored by the hierarchical data structure represents a part of an item associated with a network address.

13. The information interaction module of claim 11, wherein the information interaction module is configured to store or retrieve the information item using an information source which is local with respect to the information interaction module.

14. The information interaction module of claim 11, wherein the information interaction module is configured to store or retrieve the information item using a network-accessible entity.

15. The information interaction module of claim 14, wherein the information interaction module is configured to interact with a web service interface provided by the network-accessible entity.

16. The information interaction module of claim 14, wherein the information interaction module is configured to interact with a feed-type interface provided by the network-accessible entity.

17. The information interaction module of claim 11, wherein the graphical user interface functionality is configured as a standalone browser tool.

18. The information interaction module of claim 11, wherein the graphical user interface functionality is configured to work in inline conjunction with an authoring tool.

19. The information interaction module of claim 11, wherein the graphical user interface functionality includes an option section for displaying a set of options regarding one or more subsequent key elements that are selectable by a user, the set of options being based on one or more key elements already specified by the user.

20. A computer readable medium for storing computer readable instructions, the computer readable instructions providing an information interaction module when executed by one or more processing devices, the computer readable instructions providing when implemented:
a text input section for displaying at least part of a key used to access an information item, the key being composed of plural key elements;
an option section for displaying a set of options regarding one or more subsequent key elements that are selectable by a user, the set of options being based on one or more key elements already specified by the user; and
an item presentation section for displaying an information item associated with the key when the user specifies a sufficient number of the key elements of the key to identify the information item that is associated with the key.
